(19) United States
(12) Patent Application Publication
(10) Pub. No.: US 2005/0156896 A1
(43) Pub. Date: Jul. 21, 2005

(54) Pointing method and pointing control apparatus

(75) Inventor: Kyong-yong Yu, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-Si (KR)

(21) Appl. No.: 11/019,390

(22) Filed: Dec. 23, 2004

(30) Foreign Application Priority Data
Dec. 30, 2003 (KR) 2003-100545

(51) Int. Cl. G09G 5/00

(52) U.S. Cl. 345/169

(57) ABSTRACT

A pointing control apparatus including: an input unit including a plurality of direction keys and a screen division mode control key, the input unit outputting a screen division mode signal key signal in response to a pressing of the screen division mode control key and outputting a direction key signal in response to a pressing of a direction key; a display unit which displays data on a screen; and a control unit which, when a screen division mode control key signal is received, divides the screen, and, when a direction key signal is received, moves a pointer on the display unit by a screen division interval in a direction indicated by the received direction key signal.

### CROSS-REFERENCE TO RELATED APPLICATION

This application claims the benefit of Korean Patent Application No.03-100545, filed on Dec. 30, 2003, in the Korean Intellectual Property Office, the disclosure of which is incorporated herein by reference.

### BACKGROUND OF THE INVENTION

1. Field of the Invention

The present invention relates to a pointing method and a pointing control apparatus, and more specifically, to a pointing method and a pointing control apparatus capable of being used in a system in which it is not easy to use a mouse.

2. Description of Related Art

A mouse is generally known as an auxiliary input unit of a computer. With diversification of functions of electronic apparatuses having a display function, such as digital televisions, a mouse pointing function such as that used in computers has been required.

For example, in the case of digital televisions, when there is provided an additional service enabling bi-directional communications between broadcasting stations or server operators and television viewers, the television viewers can enjoy Internet services such as electronic commercial transactions, etc. by using the digital televisions. In this case, users should be able to select specific data or items from data to be displayed on the digital televisions. However, it is currently difficult to rapidly and easily select desired data or items by using remote controllers for controlling the digital televisions. Therefore, the mouse pointing function used in computers is required for rapidly and easily selecting the desired data or items.

However, since functions of the electronic apparatuses such as the digital televisions are controlled remotely using wireless remote controllers unlike the computers, a wire-connected mouse used in the computers cannot be practicably applied to the electronic apparatuses at present.

For this reason, a wireless mouse or a remote controller provided with a touch pad has been suggested. However, when a wireless mouse is used, users often need another input unit in addition to the remote controller, and input environments become complicated as a result. In addition, in a remote controller provided with a touch pad, it is difficult for users to accurately perform the pointing, unless the users become skilled in use of the touch pad. Furthermore, it is not easy to perform the pointing by using a touch pad provided in a remote controller, most of which should be manipulated by a thumb of one hand.

### BRIEF SUMMARY

An aspect of the present invention provides a pointing method and a pointing control apparatus capable of rapidly and accurately performing the pointing in a system in which it is not easy to use a mouse.

An aspect of the present invention also provides a pointing method and a pointing control apparatus capable of accurately and rapidly pointing a desired position on a display screen, by using a screen division function and direction keys of an input unit.

According to an aspect of the present invention, there is provided a pointing control apparatus including: an input unit including a plurality of direction keys and a screen division mode control key, the input unit outputting a screen division mode signal key signal in response to a pressing of the screen division mode control key and outputting a direction key signal in response to a pressing of a direction key; a display unit which displays data on a screen; and a control unit which, when a screen division mode control key signal is received, divides the screen, and, when a direction key signal is received, moves a pointer on the display unit by a screen division interval in a direction indicated by the received direction key signal.

According to another aspect of the present invention, there is provided a pointing control apparatus including: a remote controller having a plurality of direction keys and a screen division mode control key and which outputs a key signal in response to a pressing of a key; a display unit which displays on a screen received broadcasting signals and/or data; a receiving unit which receives the key signal; and a control unit which, when the key signal is a screen division mode control key signal, divides the screen, and, when the key signal is a direction key signal, moves a pointer on the display unit by a screen division interval in a direction indicated by the received direction key signal.

According to another aspect of the present invention, there is provided a pointing method used in a system of which functions are controlled by an input unit comprising a plurality of direction keys and a screen division mode control key, including: dividing a data output screen in accordance with a selected division mode when a division mode of the data output screen is selected by a pressing of the screen division mode control key; and moving a pointer on the data output screen by a division interval in a direction indicated by a pressed direction key when a direction key is pressed.

According to another aspect of the present invention, there is provided a pointing control apparatus including: a display unit which displays data on a screen; and a control unit which receives a key signal from an input device and, when the key signal is a screen division mode control key signal, divides the screen in accordance with the key signal, and, when the key signal is a direction key signal, moves a pointer on the display unit by a screen division interval in a direction indicated by the key signal, wherein the input unit includes a plurality of direction keys and a screen division mode control key and outputs a key signal indicating a screen division in response to a pressing of the screen division mode signal key and outputs a key signal indicating a direction in response to a pressing of the direction key.

According to another aspect of the present invention, there is provided A method of increasing a speed of pointing a pointer on a screen, including: determining whether a pressed key is a screen division mode control key and, when the pressed key is a screen division mode control key, increasing or decreasing a number of screen divisions; determining whether the pressed key is a direction key when the pressed key is not a screen division mode control key and when the pressed key is a direction key, moving the pointer by a division interval in a direction indicated by the pressed key; and performing a function corresponding to the pressed key when the pressed key is not a screen division mode control key or a direction key.

Additional and/or other aspects and advantages of the present invention will be set forth in part in the description which follows and, in part, will be obvious from the description, or may be learned by practice of the invention.

### BRIEF DESCRIPTION OF THE DRAWINGS

These and/or other aspects and advantages of the present invention will become apparent and more readily appreciated from the following detailed description, taken in conjunction with the accompanying drawings of which:

FIG. 1 is a black diagram illustrating a system to which a pointing control apparatus according to an embodiment of the present invention is applicable;

FIG. 2 is a diagram illustrating functional keys provided in an input section of the remote controller shown in FIG. 1;

FIGS. 3A to 3D illustrate an example of a screen division interval to be displayed on a display unit according to an embodiment of the invention;

FIGS. 4A to 4C illustrate another example of the screen division interval to be displayed on the display unit according to an embodiment of the invention;

FIGS. 5A to 5C illustrate still another example of the screen division interval to be displayed on the display unit an embodiment of the invention; and

FIG. 6 is a flowchart illustrating a pointing method according to an embodiment of the invention.

### DETAILED DESCRIPTION OF EMBODIMENTS

Reference will now be made in detail to an embodiment of the present invention, examples of which are illustrated in the accompanying drawings, wherein like reference numerals refer to the like elements throughout. The embodiment is described below in order to explain the present invention by referring to the figures.

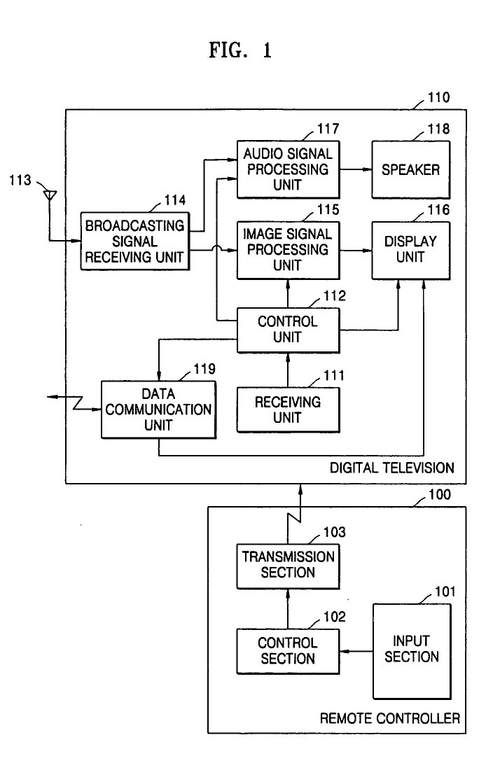

FIG. 1 is a block diagram illustrating a system to which a pointing control apparatus according to an embodiment of the present invention is applicable. The system shown in FIG. 1 is a digital television 110 which can perform a bidirectional communication under control of a remote controller 100.

The remote controller 100 shown in FIG. 1 includes an input section 101, a control section 102, and a transmission section 103.

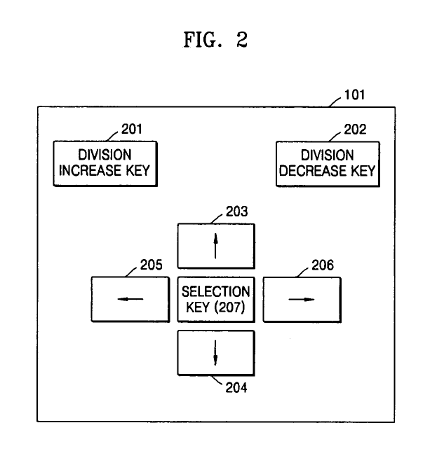

The input section 101 includes, as shown in FIG. 2, a division increase key 201, a division decrease key 202, an upward direction key 203, a downward direction key 204, a left direction key 205, a right direction key 206, and a selection key 207.

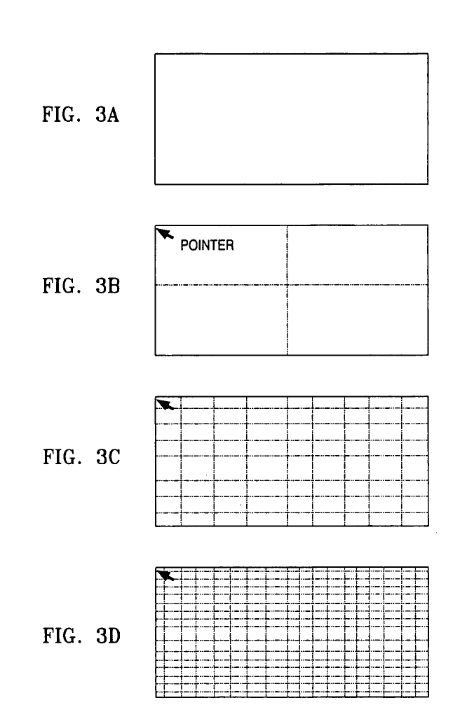

The division increase key 201 is a control key that increases the number of area divisions of a screen displayed on the display unit 116 included in the digital television 110. That is, if the division increase key 201 is pressed once, the screen of the display unit 116 shown in FIG. 3A can be divided into 2×2 areas shown in FIG. 3B.

When the screen is divided as shown in FIG. 3B, if the division increase key 201 is pressed again, the screen displayed on the display unit 116 can be more finely divided as shown in FIG. 3C.

When the screen is divided as shown in FIG. 3C, if the division increase key 201 is pressed again, the screen displayed on the display unit 116 can be still more finely divided as shown in FIG. 3D.

The numbers of screen divisions shown in FIGS. 3C and 3D are examples. The number of screen divisions is set in accordance with a previously set condition. For example, in a case where the number of screen divisions is set such that the screen is re-divided into 8×8 areas if the division increase of the screen divided into 2×2 areas is requested, the screen is re-divided into 32×32 areas if the division increase of the screen divided into 8×8 areas is requested, and the screen is re-divided into 128×128 areas if the division increase of the screen divided into 32×32 areas is requested, the screen on the display unit 116 can be divided in accordance with the division modes set correspondingly to the number of presses on the division increase key 201.

The division decrease key 202 is a control key that decreases the number of area divisions of the screen displayed on the display unit 116 included in the digital television 110. That is, the division decrease key 202 functions oppositely to the division increase key 201. Therefore, each time the division decrease key 202 is pressed, the number of area divisions of the screen displayed on the display unit 116 is decreased from FIG. 3D to FIG. 3C, and from FIG. 3C to FIG. 3B.

A large number of divisions of the screen displayed on the display unit 116 results in a small division interval, and a small number of divisions of the screen results in a large division interval. Therefore, a pointer can be moved up to a desired position for a short time, by increasing or decreasing the division interval of the screen displayed on the display unit 116 by selectively using the division increase key 201 and the division decrease key 202 in accordance with a position to which the pointer should be moved.

The upward direction key 203, the downward direction key 204, the left direction key 205, and the right direction key 206 are used to indicate a direction in which the pointer displayed on the display unit 116 should be moved. Therefore, the pointer displayed on the display unit 116 is moved upwardly if the upward direction key 203 is pressed, the pointer displayed on the display unit 116 is moved downwardly if the downward direction key 204 is pressed, the pointer displayed on the display unit 116 is moved left if the left direction key 205 is pressed, and the pointer displayed on the display unit 116 is moved right if the right direction key 206 is pressed.

The selection key 207 functions like clicking a mouse when the pointer reaches a desired position.

Referring to FIG. 1, when one of the keys provided in the input unit 101 is pressed, the control section 102 transmits a signal corresponding to the pressed key to the transmission section 103.

The transmission section 103 transmits the signal transmitted from the control section 102 to the digital television 110.

The digital television 110 includes a receiving unit 111, a control unit 112, an antenna 113, a broadcasting signal receiving unit 114, an image signal processing unit 115, a display unit 116, an audio signal processing unit 117, a speaker 118, and a data communication unit 119.

The receiving unit 111 receives the signal transmitted from the remote controller 100.

The control unit 112 controls functions of the digital television 110 in accordance with the signal received from the receiving unit 111. Specifically, when a screen division mode control key signal is received from the remote controller 100 through the receiving unit 111, the control unit 112 sets the screen division mode on the display unit 116, and divides the screen displayed on the display unit 116 in accordance with the set division mode. In a state where the screen division mode on the display unit 116 is set, every time when a signal of one direction key of the plurality of direction keys is received from the remote controller 100 through the receiving unit 111, the control unit 112 moves the pointer on the display unit 116 by a screen division interval in a direction indicated by the received direction key signal. At this time, the screen division interval can be varied in response to the screen division mode control key signal.

The antenna 113 receives broadcasting signals transmitted from a broadcasting station. The broadcasting signal receiving unit 114 receives broadcasting signals of a specific channel under control of the control unit 112.

The image signal processing unit 115 processes the image signals transmitted from the broadcasting signal receiving unit 114 to be displayed on the display unit 116 under control of the control unit 112. The display unit 116 outputs the image signals output from the image signal processing unit 115 and/or data output from the data communication unit 119. The audio signal processing unit 117 processes audio signals transmitted from the broadcasting signal receiving unit 114 to be output through the speaker 118. The speaker 118 outputs the received audio signals.

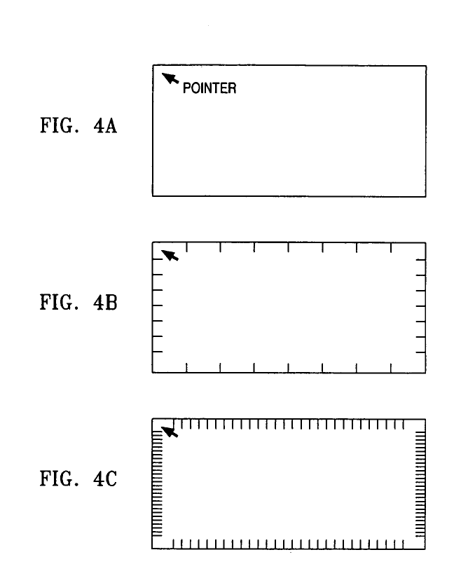

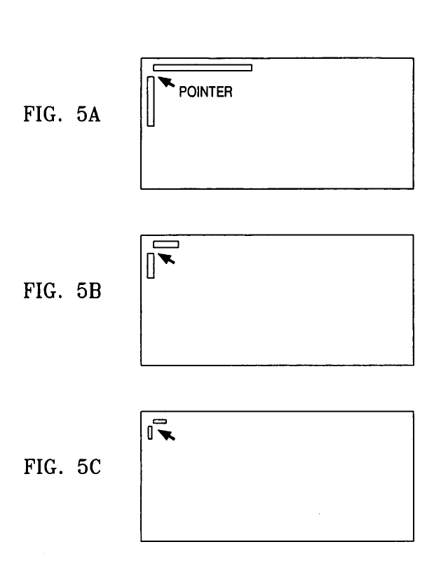

FIGS. 4A to 4C illustrate another example of the screen division interval to be displayed on the display unit 116 according to the present embodiment. FIGS. 5A to 5C illustrate still another example of the screen division interval to be displayed on the display unit 116 according to the present embodiment. The screen division interval currently set may not be displayed on the display unit 116.

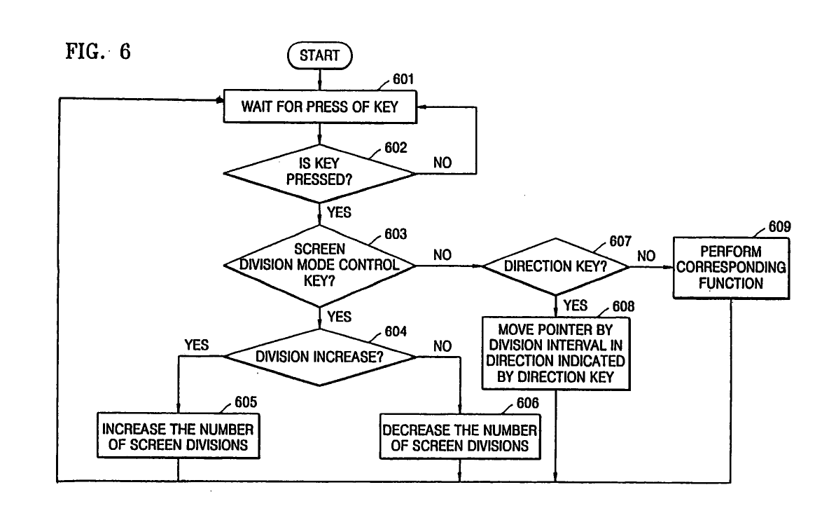

FIG. 6 is a flowchart illustrating a pointing method according to the present embodiment.

Referring to FIGS. 1 and 6, in a state of waiting for one of keys of the input unit such as the remote controller 100 to be pressed (operation 601), if the press of a key is recognized (operation 602), the control unit 112 determines whether the pressed key is the screen division mode control key (operation 603).

If it is determined in operation 603 that it is the screen division mode control key, the control unit 112 determines whether the screen division mode control key is the division increase request key (operation 604). If it is determined in operation 604 that it is the division increase request key, the control unit 112 increases the number of area divisions of the screen on the display unit 116 (operation 605), and returns to operation 601. However, if it is determined in operation 604 that it is the division decrease request key, the control unit 112 performs operation 606 to decrease the number of area divisions of the screen on the display unit 116, and returns to operation 601.

If it is determined in operation 603 that it is not the screen division mode control key, the control unit 112 determines whether one of the direction keys has been pressed (operation 607). If it is determined in operation 607 that one of the upward, downward, left, and right direction keys is pressed, the control unit 112 moves the pointer by a currently-set division interval in a direction indicated by the pressed direction key (operation 608), and returns to operation 601.

If it is determined in operation 607 that no direction key is pressed, the control unit 112 performs a function corresponding to the pressed key (operation 609), and returns to operation 601.

Therefore, the screen division interval can be changed and thus the movement interval of the pointer can be adjusted, by changing the screen division mode by means of the division increase key 201 and the division decrease key 202 provided in the remote controller 100 during moving the pointer up to a desired position.

In the above embodiment, a digital television to be controlled by a remote controller is described. However, it is to be understood that the present invention may be applied to a system in which it is not easy to use a mouse and it is possible to use direction keys.

According to the described embodiment of the present invention, it is possible to rapidly point a desired position without using a mouse, by dividing a displayed screen using a screen division control key provided in a remote controller, and moving a pointer by a division interval using direction keys of the remote controller.

Furthermore, since the division interval can be freely changed in the course of moving the pointer to a desired position, the division interval can be finely adjusted in accordance with a position to be pointed, so that it is possible to accurately point a desired position.

Further, in the described embodiment of the present invention, since environments in which a remote controller is used are sufficiently considered, change of a user's posture is not required for the pointing.

Although an embodiment of the present invention have been shown and described, the present invention is not limited to the described embodiment. Instead, it would be appreciated by those skilled in the art that changes may be made to the embodiment without departing from the principles and spirit of the invention, the scope of which is defined by the claims and their equivalents.

1. A pointing control apparatus comprising:
an input unit including a plurality of direction keys and a screen division mode control key, the input unit outputting a screen division mode signal key signal in response to a pressing of the screen division mode control key and outputting a direction key signal in response to a pressing of a direction key;
a display unit which displays data on a screen; and
a control unit which, when the screen division mode control key signal is received, divides the screen, and, when the direction key signal is received, moves a pointer on the display unit by a screen division interval in a direction indicated by the received direction key signal.

2. The pointing control apparatus according to claim 1, wherein the screen division mode control key includes a division increase request key and a division decrease request key which respectively increase and decrease a number of area divisions of the screen.

3. The pointing control apparatus according to claim 1, wherein the control unit allows a screen division interval to be displayed on the display unit, the screen division interval corresponding to a screen division mode set in response to the screen division mode control key signal.

4. The pointing control apparatus according to claim 1, wherein the control unit changes the screen division interval each time the screen division mode control key signal is received.

5. A pointing control apparatus comprising:
a remote controller having a plurality of direction keys and a screen division mode control key and which outputs a key signal in response to a pressing of a key;
a display unit which displays on a screen received broadcasting signals and/or data;
a receiving unit which receives the key signal; and
a control unit which, when the key signal is a screen division mode control key signal, divides the screen, and, when the key signal is a direction key signal, moves a pointer on the display unit by a screen division interval in a direction indicated by the received direction key signal.

6. A pointing method used in a system of which functions are controlled by an input unit comprising a plurality of direction keys and a screen division mode control key, comprising:
dividing a data output screen in accordance with a selected division mode when a division mode of the data output screen is selected by a pressing of the screen division mode control key; and
moving a pointer on the data output screen by a division interval in a direction indicated by a pressed direction key when a direction key is pressed.

7. The pointing method according to claim 6, further comprising:
displaying the division interval corresponding to the selected division mode on the data output screen.

8. The pointing method according to claim 6, wherein the division mode includes a plurality of division modes for increasing the number of divisions of the data output screen and a plurality of division modes for decreasing the number of divisions of the data output screen.

9. The pointing method according to claim 6, further comprising:
varying the division mode of the data output screen using the screen division mode control key, so that the division interval is changed at least once while moving the pointer up to a desired position.

10. A pointing control apparatus comprising:
a display unit which displays data on a screen; and
a control unit which receives a key signal from an input device and, when the key signal is a screen division mode control key signal, divides the screen in accordance with the key signal, and, when the key signal is a direction key signal, moves a pointer on the display unit by a screen division interval in a direction indicated by the key signal,
wherein the input unit includes a plurality of direction keys and a screen division mode control key and outputs a key signal indicating a screen division in response to a pressing of the screen division mode signal key and outputs a key signal indicating a direction in response to a pressing of the direction key.

11. The pointing control apparatus of claim 10, wherein the input unit includes a selection key, the key signal indicates a selection in response to a pressing of the selection key, and the control unit selects an object displayed on the screen when the key signal indicated a selection.

12. A method of increasing a speed of pointing a pointer on a screen, comprising:
determining whether a pressed key is a screen division mode control key and, when the pressed key is a screen division mode control key, increasing or decreasing a number of screen divisions;
determining whether the pressed key is a direction key when the pressed key is not a screen division mode control key and when the pressed key is a direction key, moving the pointer by a division interval in a direction indicated by the pressed key; and
performing a function corresponding to the pressed key when the pressed key is not a screen division mode control key or a direction key.

13. The method of claim 12, wherein the function is a selecting operation.
